(19) United States
(12) Patent Application Publication
(10) Pub. No.: US 2024/0088412 A1
(43) Pub. Date: Mar. 14, 2024

(54) FUEL CELL POWER GENERATION DEVICE

(71) Applicants: The Hong Kong Polytechnic University, Hong Kong (CN); Yee Hop Environmental Protection Limited, Hong Kong (CN)

(72) Inventors: Ka Wai Eric Cheng, Hong Kong (CN); Yuk Ping Cho, Hong Kong (CN)

(73) Assignees: The Hong Kong Polytechnic University, Hong Kong (CN); Yee Hop Environmental Protection Limited, Hong Kong (CN)

(21) Appl. No.: 18/365,697

(22) Filed: Aug. 4, 2023

(30) Foreign Application Priority Data
Sep. 14, 2022 (CN) 202211114113.5

(51) Int. Cl. H01M 8/04082; H01M 8/04007; H01M 8/04089; H01M 8/04746; H01M 8/0662; H01M 16/00

(52) U.S. Cl. CPC H01M 8/04201; H01M 8/04007; H01M 8/04089; H01M 8/04753; H01M 8/0687; H01M 16/006

(57) ABSTRACT

Embodiments of the present disclosure provide a fuel cell power generation device, which includes: a fuel cell with an anode and a cathode, for decomposing hydrogen and generating electric energy through reaction of decomposed hydrogen and oxygen; a first delivery pipe connected between a pipeline of a hydrogen-containing gas and the fuel cell, for delivering the hydrogen-containing gas to the anode of the fuel cell; a first output pipe connected to the fuel cell, for discharging a first remaining gas contacted with the anode of the fuel cell; a second delivery pipe connected to the fuel cell, for delivering an oxygen-containing gas to the cathode of the fuel cell; and a second output pipe connected to the fuel cell, for discharging a second remaining gas contacted with the cathode of the fuel cell.

### CROSS-REFERENCE TO RELATED APPLICATIONS

This application is based upon and claims priority to Chinese Patent Application No. 202211114113.5, filed Sep. 14, 2022, the entire contents of which is incorporated herein by reference.

### TECHNICAL FIELD

The present disclosure relates to a field of a fuel cell technology, and more particularly, to a fuel cell power generation device.

### BACKGROUND

Electric power is widely used in people's daily life. An existing backup power supply includes a backup generator that has an uninterruptible power supply and is powered by a diesel generator. The uninterruptible power supply and the diesel generator may cause an environmental issue. An existing domestic coal gas is generally used for direct combustion, and is not directly used for the backup power supply.

It should be noted that the information disclosed in the BACKGROUND section is only used to facilitate understanding of the background of the present disclosure, and therefore may include information that does not constitute the prior art known to those in the art.

### SUMMARY

A fuel cell power generation device provided by embodiments of the present disclosure may be connected to a coal gas pipeline in home or other buildings to provide a second backup power.

Additional features and advantages of the present disclosure will become apparent from the following detailed description, or may be learned in part by practice of the present disclosure.

According to an aspect of the present disclosure, a fuel cell power generation device is provided and includes: a fuel cell, including an anode and a cathode, configured to decompose hydrogen and generate electric energy through reaction of decomposed hydrogen and oxygen; a first delivery pipe, connected between a pipeline of a hydrogen-containing gas and the fuel cell and configured to deliver the hydrogen-containing gas to the anode of the fuel cell; a first output pipe, connected to the fuel cell and configured to discharge a first remaining gas contacted with the anode of the fuel cell; a second delivery pipe, connected to the fuel cell and configured to deliver an oxygen-containing gas to the cathode of the fuel cell; a second output pipe, connected to the fuel cell and configured to discharge a second remaining gas contacted with the cathode of the fuel cell. It is to be understood that both the foregoing general description and the following detailed description are exemplary and explanatory only and are not restrictive of the present disclosure.

### BRIEF DESCRIPTION OF THE DRAWINGS

Some illustrative embodiments of the present disclosure are described in the following drawings, in which same reference numerals represent same elements. These described embodiments are intended to be exemplary embodiments of the present disclosure, which is not intended to limit the present disclosure.

FIG. 1 shows a structural diagram of a fuel cell power generation device in one embodiment of the present disclosure;

FIG. 2 shows a structural diagram of a fuel cell power generation device in one embodiment of the present disclosure;

FIG. 3 shows a structural diagram of a fuel cell power generation device in one embodiment of the present disclosure;

FIG. 4 shows a structural diagram of a fuel cell power generation device in one embodiment of the present disclosure;

FIG. 5 shows a structural diagram of a fuel cell power generation device in one embodiment of the present disclosure;

FIG. 6 shows a structural diagram of a fuel cell power generation device in one embodiment of the present disclosure;

FIG. 7 shows a schematic diagram of a usage process of a fuel cell power generation device in one embodiment of the present disclosure.

### DETAILED DESCRIPTION

The examples of embodiments are now described comprehensively with reference to the accompanying drawings. However, the examples of embodiments may be implemented in multiple forms, and it should not be understood as being limited to the examples described herein. Conversely, the embodiments are provided to make this disclosure more comprehensive and complete, and comprehensively convey the idea of the examples of the embodiments to those in the art.

In addition, the described features, structures, or properties may be combined in one or more embodiments in any appropriate manner. In the following descriptions, specific details are provided to give a comprehensive understanding of the embodiments of the present disclosure. However, those skilled in the art are to be aware that, the technical solutions in present disclosure may be implemented without one or more of the particular details, or another method, unit, apparatus, or step may be used. In other cases, well-known methods, apparatuses, implementations, or operations are not shown or described in detail, to avoid obscuring the aspects of the present disclosure.

The block diagrams shown in the accompany drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely examples for descriptions, do not need to include all content and operations/steps, and do not need to be performed in the described orders either. For example, some operations/steps may be further divided, while some operations/steps may be combined or partially combined. Therefore, an actual execution order may change according to an actual case.

Electric power is widely used in people's daily life, but power failure may occur. Thus, having a second power supply in a building or home may guarantee power supply in the building or home in case of the power failure. Although an uninterruptible power supply (UPS) that is based on a battery may provide this kind of guarantee, the power design of the UPS only lasts for several minutes and the UPS then stops. For a backup generator powered by a diesel generator, good maintenance and storage of diesel fuel are required. There are also environmental issues with the UPS and the diesel generator.

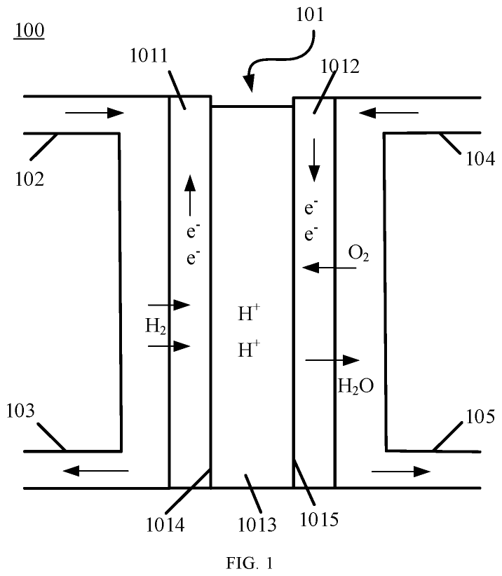

FIG. 1 shows a structural diagram of a fuel cell power generation device 100 in one embodiment of the present disclosure.

As shown in FIG. 1, the fuel cell power generation device 100 of the present disclosure at least includes a fuel cell 101, a first delivery pipe 102, a first output pipe 103, a second delivery pipe 104, and a second output pipe 105. The fuel cell 101 at least includes an anode 1011 and a cathode 1012, and is configured to decompose hydrogen input from the first delivery pipe 102 and generate electric energy through reaction of decomposed hydrogen and oxygen; the first delivery pipe 102 is connected between a pipeline of a hydrogen-containing gas and the fuel cell 101, and is configured to deliver the hydrogen-containing gas to the anode 1011 of the fuel cell 101; the first output pipe 103 is connected to the fuel cell 101 and is configured to discharge a first remaining gas contacted with the anode 1011 of the fuel cell 101; the second delivery pipe 104 is connected to the fuel cell 101 and is configured to deliver an oxygen-containing gas to the cathode 1012 of the fuel cell 101; and the second output pipe 105 is connected to the fuel cell 101 and is configured to discharge a second remaining gas contacted with the cathode 1012 of the fuel cell 101.

In one embodiment, the hydrogen-containing gas is a coal gas and the oxygen-containing gas is an air.

The fuel cell 101 further at least includes a proton exchange membrane (PEM) 1013 between the anode 1011 and the cathode 1012, a first catalyst 1014 and a second catalyst 1015. The hydrogen-containing gas contacts the anode 1011 of the fuel cell via the first delivery pipe 102, the hydrogen in the hydrogen-containing gas is decomposed into two protons and two electrons under action of the first catalyst 1014. The protons are ‘attracted’ to the other side of PEM 1013 by oxygen, while the electrons form a current via an external circuit and then reach the cathode 1012. Under action of the second catalyst 1015 of the cathode, the protons, oxygen and electrons react to form water molecules. A remaining gas of the hydrogen-containing gas (the first remaining gas) is output via the first output pipe 103. When the hydrogen-containing gas is the coal gas, the first remaining gas may be connected and delivered via the second delivery pipe 104 to be used as a common gas fuel for heating, cooking and boilers.

The proton exchange membrane is a core component of a proton exchange membrane fuel cell (PEMFC), which plays a key role in battery performance. Inside the fuel cell, the proton exchange membrane provides a channel for proton migration and delivery, such that the protons pass through the proton exchange membrane from the anode to the cathode and form a loop with electron transfer of the external circuit to provide a current to the outside. Thus, performance of the proton exchange membrane plays a very important role in performance of the fuel cell, and its quality directly affects service life of the battery.

The oxygen-containing gas is connected to the cathode of the fuel cell via the second delivery pipe 104. The oxygen in the oxygen-containing gas generates water molecules with the protons and the electrons at the cathode under the action of the catalyst. When the oxygen-containing gas is the air, the water molecules and the remaining air are discharged via the second output pipe 105.

In the fuel cell power generation device in FIG. 1, the fuel cell decomposes the hydrogen and the decomposed hydrogen reacts with oxygen to generate the electric energy; the first delivery pipe is connected between a pipeline of a hydrogen-containing gas and the fuel cell and configured to deliver the hydrogen-containing gas to the anode of the fuel cell; the first output pipe is connected to the fuel cell and configured to discharge a first remaining gas contacted with the anode of the fuel cell; the second delivery pipe is connected to the fuel cell and configured to deliver the oxygen-containing gas to the cathode of the fuel cell; the second output pipe is connected to the fuel cell and configured to discharge the second remaining gas contacted with the cathode of the fuel cell, which is suitable for connecting with a coal gas pipelines in the home or other buildings, so as to provide the second backup power.

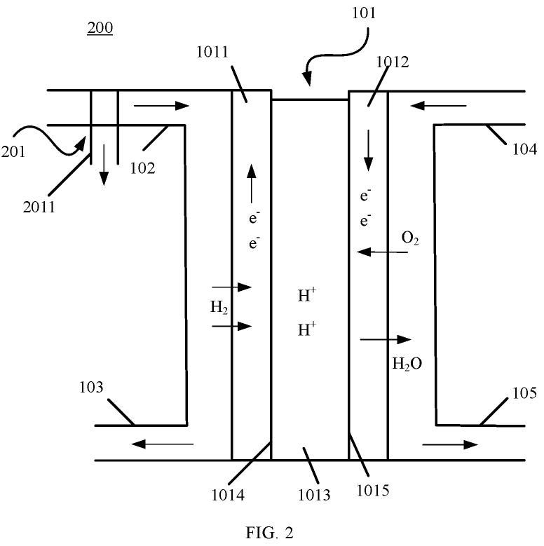

FIG. 2 shows a structural diagram of a fuel cell power generation device 200 in one embodiment of the present disclosure.

Referring to FIG. 2, the fuel cell power generation device 200 in FIG. 2 further includes a hydrogen separator 201 connected to the first delivery pipe 102 and configured to deliver hydrogen to the anode 1011 of the fuel cell through the first delivery pipe 102 after extracting the hydrogen from the hydrogen-containing gas. The hydrogen separator 201 may further include a third output pipe 2011 configured to discharge the remaining gas after the hydrogen extraction. When the hydrogen-containing gas is the coal gas, the hydrogen separator 201 may be directly connected to the coal gas pipeline, and the hydrogen is extracted from the coal gas and then input to the anode 1011 of the fuel cell, and the remaining gas is output through the third output pipe 2011 to be used as a common gas fuel for heating, cooking and boiler, or stored for backup.

In one embodiment, the hydrogen separator 201 may, for example, adopt a pressure swing adsorption technology or a membrane separation technology, which is not limited in the present disclosure, as long as it is a technology that may separate the hydrogen. The pressure swing adsorption technology is generally based on a method of pressure and compression to separate gas in different pressurized forms under different pressures and temperatures.

The fuel cell power generation device in FIG. 2 may increase contact efficiency between the hydrogen and the anode by setting a hydrogen separator 201 to separate hydrogen and directly input the hydrogen to the anode of the fuel cell.

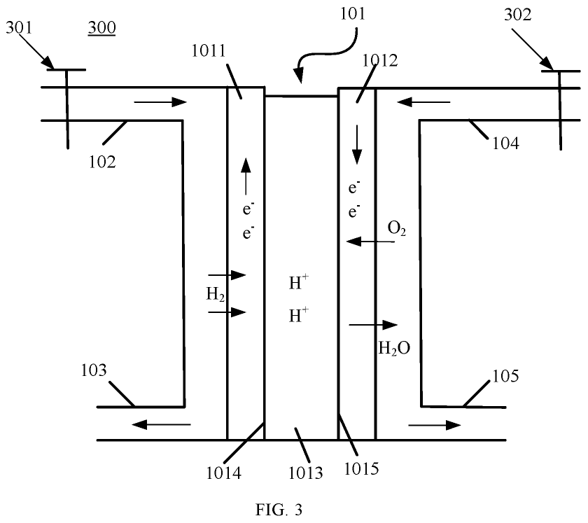

FIG. 3 shows a structural diagram of a fuel cell power generation device 300 in one embodiment of the present disclosure.

Referring to FIG. 3, the fuel cell power generation device 300 of FIG. 3 further includes a first flow controller 301 and a second flow controller 302; the first flow controller 301 is mounted to the first delivery pipe 102 and configured to control a gas flow of the hydrogen-containing gas delivered to the anode 1011 of the fuel cell 101; the second flow controller 302 is mounted to the second delivery pipe 104 and configured to control a gas flow of the oxygen-containing gas delivered to the cathode 1012 of the fuel cell 101.

The fuel cell power generation device in FIG. 3 may control the flows of the hydrogen-containing gas and the oxygen-containing gas by setting the first flow controller and the second flow controller, so as to control the power generation efficiency of the fuel cell power generation device.

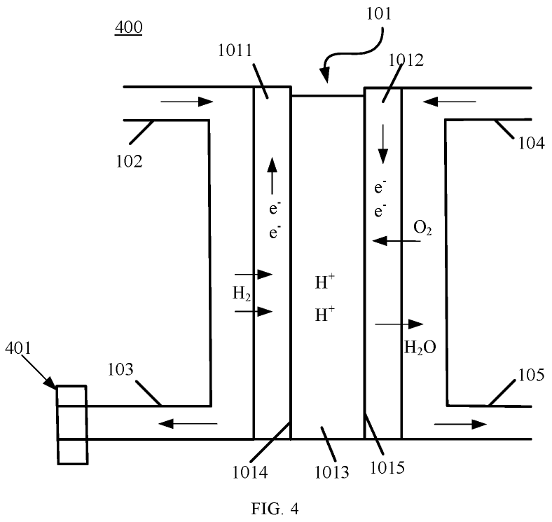

FIG. 4 shows a structural diagram of a fuel cell power generation device 400 in one embodiment of the present disclosure.

Referring to FIG. 4, the fuel cell power generation device 400 of FIG. 4 further includes a cooler 401. The cooler 401 is mounted to the first output pipe 103 and is configured to cool the first remaining gas. A temperature of the first remaining gas that completed the contact with the anode 1011 of the fuel cell 101 generally rises and the temperature is relatively high. To reduce a problem caused by the rise of the gas, the cooler 401 may be mounted to the first output pipe 103 to reduce the temperature of the first remaining gas. The cooler 401 may be a long metal cooling coil with an increased surface area to achieve cooling, or the cooler may use other electrical cooling systems, such as a cooling fan with a radiator, which is not limited herein.

The fuel cell power generation device in FIG. 4 may reduce the temperature of the first remaining gas by setting the cooler, thus eliminating a potential safety hazard due to the high temperature of the first remaining gas.

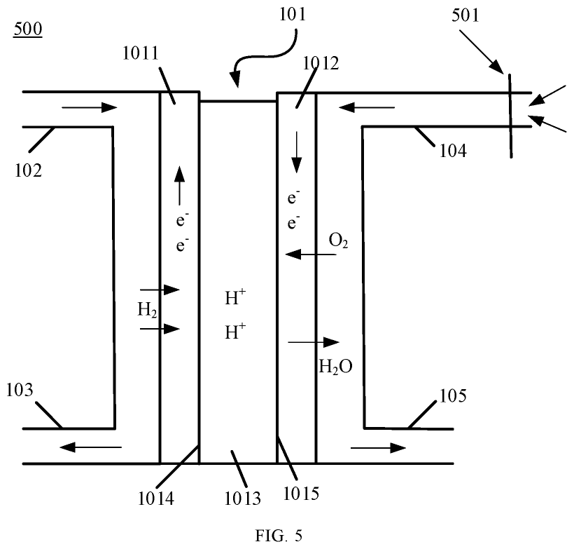

FIG. 5 shows a structural diagram of a fuel cell power generation device 500 in one embodiment of the present disclosure.

Referring to FIG. 5, the fuel cell power generation device 500 of FIG. 5 further includes an air drive 501. The air driver 501 is mounted to the second delivery pipe 104 and configured to drive (suck) the air to the second delivery pipe 104 when the oxygen-containing gas is the air, thereby increasing an air supply speed and improving the power generation efficiency of the fuel cell power generation device 500. The air drive 501 is, for example, a fan, which is not limited herein.

The fuel cell power generation device in FIG. 5 may increase the air supply speed and improve the power generation efficiency of the fuel cell power generation device by setting the air driver.

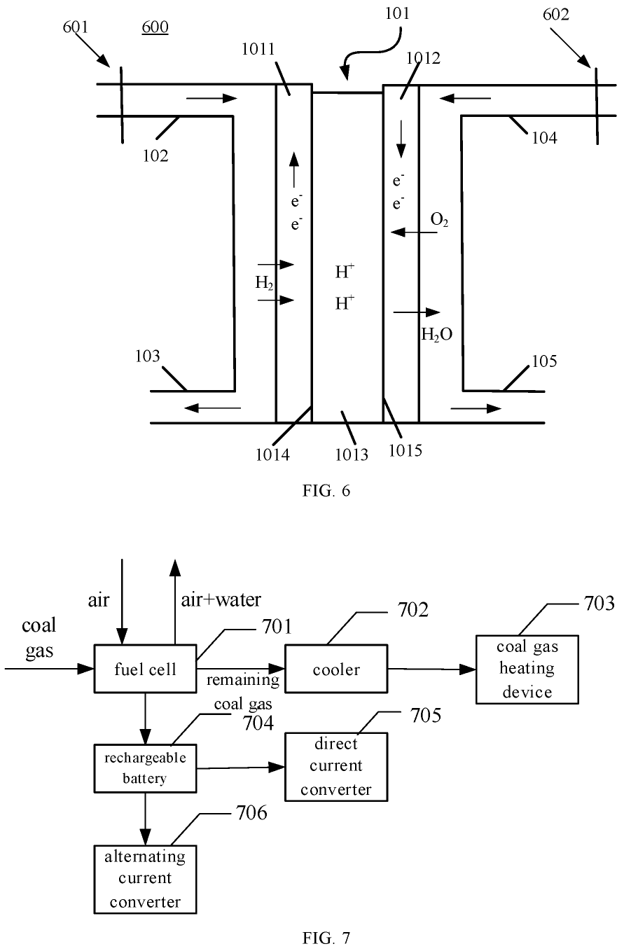

FIG. 6 shows a structural diagram of a fuel cell power generation device 600 in one embodiment of the present disclosure.

Referring to FIG. 6, the fuel cell power generation device 600 of FIG. 6 further includes a hydrogen-containing gas filter 601 and an air filter 602. The hydrogen-containing gas filter 601 is connected to the first delivery pipe 102 and configured to filter a corrosive gas in the hydrogen-containing gas; the air filter 602 is connected to the second delivery pipe 104 and configured to filter a corrosive gas in the oxygen-containing gas.

The fuel cell power generation device in FIG. 6 may filter the corrosive gases in the hydrogen-containing gas and in the air by setting the hydrogen-containing gas filter and the air filter, so as to improve a service life of the fuel cell power generation device.

FIG. 7 shows a schematic diagram of a usage process of a fuel cell power generation device in one embodiment of the present disclosure.

Referring to FIG. 7, a coal gas and an air are respectively delivered to an anode and a cathode of the fuel cell 701 through a delivery pipe. After the coal gas contacted with the anode of the fuel cell 701 is discharged, the coal gas is cooled by a cooler 702 and then input to a coal gas heating device 703; the air contacted with the cathode of the fuel cell 701 is discharged with a remaining air and a generated water after the oxygen reacts with protons and electrons. A rechargeable battery 704 is connected to the anode and the cathode of the fuel cell, and is configured to store and buffer the electric energy generated by the fuel cell. A direct current converter 705 is connected to the rechargeable battery 704 and is configured to convert the electric energy of the rechargeable battery into direct current electric energy suitable for use by a load. An alternating current converter 706 is connected to the rechargeable battery 704, and configured to convert the electric energy of the rechargeable battery into alternating current electric energy suitable for use by a load.

In the schematic diagram of the usage process of the fuel cell power generation device shown in FIG. 7, the anode and the cathode of the fuel cell are connected through the rechargeable battery, so as to store and buffer the electric energy generated by the fuel cell, and the direct current converter is connected to the rechargeable battery and is configured to convert the electric energy of the rechargeable battery into the direct current electric energy suitable for use by the load; the alternating current converter is connected to the rechargeable battery and is configured to convert the electric energy of the rechargeable battery into the alternating current electric energy suitable for use by the load, so as to achieve the direct use of the electric energy provided by the fuel cell power generation device.

The coal gas has a typical composition of hydrogen 50%, methane 35%, carbon monoxide 10% and ethylene 5%. Although different coal gases in different cities may have slightly difference in its composition, this composition represents a typical and common composition. It can be seen that the hydrogen amounts to 50% and the rest is hydrocarbon fuel or carbon monoxide fuel. For methane, its chemical formula is CH₄, and ethylene's chemical formula is C₂H₄. 50% content of hydrogen is non-greenhouse gas fuel. It is to connect the coal gas to the hydrogen fuel cell and the hydrogen is then converted to stream through the PEM. The gases including methane, carbon monoxide and ethylene are not activated by PEM.

For a case without using the fuel cell, the typical efficiency to convert from fuel to energy is η_{ch}. A typical parameter for η_{ch} is 15%. For the fuel cell, its efficiency rift is 50%. Energy content of the four fuel gases found in the coal gas may be tabulated as follows:

TABLE 1

| | MJ/m³ | ratio in coal gas |
|---|---|---|
| | E_{H2}, E_{CH4}, | by volume |
| | E_{CO}, E_{C2H4} | R_{H2}, R_{CH4}, |
| | (energy density) | R_{CO}, R_{C2H4} |
| hydrogen H₂ | 11.8 | 50% |
| methane CH₄ | 37 | 35% |
| carbon monoxide CO | 11.8 | 10% |
| ethylene C₂H₄ | 110 | 5% |

After using the fuel cell power generation device of the present disclosure, a theoretical efficiency of the coal gas may be obtained by using a following formula (1):

$${η}_{overall} = \frac{\begin{matrix}{E}_{H 2} {R}_{H 2} {η}_{FC \_ H 2} + {E}_{CH 4} {R}_{CH 4} {η}_{CH 4} + \\ {E}_{CO} {R}_{CO} {η}_{CO} + {E}_{C 2 H 4} {R}_{C 2 H 4} {η}_{C 2 H 4}\end{matrix}}{{E}_{H 2} {R}_{H 2} + {E}_{CH 4} {R}_{CH 4} + {E}_{CO} {R}_{CO} + {E}_{C 2 H 4} {R}_{C 2 H 4}} \qquad ( 1 )$$

where E_{H2}, E_{CH4}, E_{CO} and E_{C2H4} are an energy density per unit volume of H₂, CH₄, CO and C₂H₄ respectively, R_{H2}, R_{CH4}, R_{CO} and R_{C2H4} are a volume ratio of the coal gas of H₂, CH₄, CO and C₂H₄ respectively, and η_{FC_H2} is the fuel cell efficiency and flaw, η_{CO} and η_{C2H4} are the efficiency of the gas fuel to output of CH₄, CO and C₂H₄ respectively. According to formula (1), the theoretical efficiency is the 23%, which is much higher than the combustion efficiency of the gas fuel which is 15%.

An energy ratio of hydrogen to remaining gases in the coal gas may be determined according to a formula (2):

$${R}_{Hs / CG} = \frac{{E}_{H 2} {R}_{H 2}}{{E}_{C H 4} {R}_{C H 4} + {E}_{CO} {R}_{CO} + {E}_{C 2 H 4} {R}_{C 2 H 4}} \qquad ( 2 )$$

For a certain flow rate Fₕₑ (L/min) of the remaining coal gases to the heating apparatus, the heat energy output per unit time Eₕₑ (MJ/min) from the combustion of the remaining coal gases after the fuel cell extraction of the hydrogen may be determined according to a formula (3):

Eₕₑ=Fₕₑ(E_{CH4}R_{CH4}η_{CH4}+E_{CO}R_{CO}η_{CO}+E_{C2H4}R_{C2H4}η_{C2H4}) (3)

A corresponding electric energy output E_{FC} (MJ/min) may be determined according to a formula (4):

$${E}_{F C} = {F}_{h e} \frac{{R}_{H 2}}{{R}_{C H 4} + {R}_{CO} + {R}_{C 2 H 4}} {E}_{H 2} {η}_{F {C}_{H 2}} \qquad ( 4 )$$

Energy requirement stored in the battery is E_{bat}, in a case of known operation duration, it may be determined according to according to a formula (5):

E_{bat}=E_{FC}Tₕₑ (5)

In an embodiment, the hydrogen-containing gas is a coal gas and the oxygen-containing gas is an air.

In an embodiment, the device further includes a hydrogen separator, connected to the first delivery pipe and configured to deliver hydrogen to the anode of the fuel cell through the first delivery pipe after extracting the hydrogen from the hydrogen-containing gas.

In an embodiment, the device further includes a first flow controller, mounted to the first delivery pipe and configured control a gas flow of the hydrogen-containing gas delivered to the anode of the fuel cell; a second flow controller, mounted on the second delivery pipe and configured to control a gas flow of the oxygen-containing gas delivered to the cathode of the fuel cell.

In an embodiment, the device further includes a cooler, mounted to the first output pipe, and configured to cool the first remaining gas.

In an embodiment, the device further includes an air driver, mounted to the second delivery pipe, and configured to drive the air to the second delivery pipe.

In an embodiment, the device further includes a rechargeable battery, connected to the anode and cathode of the fuel cell and configured to store and buffer the electric energy generated by the fuel cell.

In an embodiment, the device further includes a direct current converter, connected to the rechargeable battery to convert the electric energy of the rechargeable battery into direct current electric energy suitable for use by a load.

In an embodiment, the device further includes an alternating current converter, connected to the rechargeable battery and configured to convert the electric energy of the rechargeable battery into alternating current electric energy suitable for use by a load.

In an embodiment, the device further includes a hydrogen-containing gas filter, connected to the first delivery pipe and configured to filter a corrosive gas in the hydrogen-containing gas; an air filter, connected to the second delivery pipe and configured to filter a corrosive gas in the oxygen-containing gas.

According to the fuel cell power generation device of the present disclosure, the fuel cell decomposes the hydrogen and the decomposed hydrogen reacts with oxygen to generate the electric energy; the first delivery pipe is connected between a pipeline of a hydrogen-containing gas and the fuel cell and delivers the hydrogen-containing gas to the anode of the fuel cell; the first output pipe is connected to the fuel cell and configured to discharge a first remaining gas contacted with the anode of the fuel cell; the second delivery pipe is connected to the fuel cell and configured to deliver the oxygen-containing gas to the cathode of the fuel cell; the second output pipe is connected to the fuel cell and configured to discharge the second remaining gas contacted with the cathode of the fuel cell, which is suitable for connecting with a coal gas pipelines in the home or other buildings, so as to provide the second backup power.

In the specification, claims, and accompanying drawings of the present disclosure, the terms “first”, “second”, and “third”, and the like are intended to distinguish between different objects but do not indicate a particular order. In addition, the term “including” and any other variant thereof, are intended to cover a non-exclusive inclusion. For example, a process, a method, an apparatus, a product, or a device that includes a series of steps or units is not limited to the listed steps or units, but optionally further includes an unlisted step or unit, or optionally further includes another inherent step or unit of the process, the method, the apparatus, the product, or the device.

A person skill in the art may be further aware that, in combination with examples of units and algorithm steps described in the embodiments disclosed in this specification, this disclosure may be implemented by using electronic hardware, computer software, or a combination thereof. To clearly describe interchangeability between the hardware and the software, compositions and steps of each example have been generally described according to functions in the foregoing descriptions. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of this disclosure.

The method and related apparatus provided by the embodiments of the present disclosure are described with reference to method flow charts and/or structure diagrams provided by the embodiments of the present disclosure. Specifically, each process and/or block of the method flow charts and/or schematic structural diagrams, and combination of processes and/or blocks in the flow charts and/or block diagrams may be implemented by computer-readable instructions. These computer-readable instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the schematic structural diagrams. These computer-readable instructions may also be stored in a computer readable memory that can guide a computer or another programmable data processing device to work in a specified manner, so that the instructions stored in the computer readable memory generate a product including an instruction apparatus, where the instruction apparatus implements functions specified in one or more procedures in the flowcharts and/or one or more blocks in the schematic structural diagrams. The computer-readable instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flow charts and/or in one or more blocks in the schematic structural diagrams.

What is disclosed above is merely preferred embodiments of this disclosure, and certainly is not intended to limit the scope of the claims of this disclosure. Therefore, equivalent variations made in accordance with the claims of this disclosure shall fall within the scope of this disclosure.

What is claimed is:

1. A fuel cell power generation device, comprising:
a fuel cell, comprising an anode and a cathode, configured to decompose hydrogen and generate electric energy through reaction of decomposed hydrogen and oxygen;
a first delivery pipe, connected between a pipeline of a hydrogen-containing gas and the fuel cell and configured to deliver the hydrogen-containing gas to the anode of the fuel cell;
a first output pipe, connected to the fuel cell and configured to discharge a first remaining gas contacted with the anode of the fuel cell;
a second delivery pipe, connected to the fuel cell and configured to deliver an oxygen-containing gas to the cathode of the fuel cell;
a second output pipe, connected to the fuel cell and configured to discharge a second remaining gas contacted with the cathode of the fuel cell.

2. The fuel cell power generation device according to claim 1, wherein the hydrogen-containing gas is a coal gas and the oxygen-containing gas is an air.

3. The fuel cell power generation device according to claim 1, further comprising:
a hydrogen separator, connected to the first delivery pipe and configured to deliver hydrogen to the anode of the fuel cell through the first delivery pipe after extracting the hydrogen from the hydrogen-containing gas.

4. The fuel cell power generation device according to claim 1, further comprising:
a first flow controller, mounted to the first delivery pipe and configured control a gas flow of the hydrogen-containing gas delivered to the anode of the fuel cell;
a second flow controller, mounted on the second delivery pipe and configured to control a gas flow of the oxygen-containing gas delivered to the cathode of the fuel cell.

5. The fuel cell power generation device according to claim 1, further comprising:
a cooler, mounted to the first output pipe, and configured to cool the first remaining gas.

6. The fuel cell power generation device according to claim 2, further comprising:
an air driver, mounted to the second delivery pipe, and configured to drive the air to the second delivery pipe.

7. The fuel cell power generation device according to claim 1, further comprising:
a rechargeable battery, connected to the anode and cathode of the fuel cell and configured to store and buffer the electric energy generated by the fuel cell.

8. The fuel cell power generation device according to claim 7, further comprising:
a direct current converter, connected to the rechargeable battery to convert the electric energy of the rechargeable battery into direct current electric energy suitable for use by a load.

9. The fuel cell power generation device according to claim 7, further comprising:
an alternating current converter, connected to the rechargeable battery and configured to convert the electric energy of the rechargeable battery into alternating current electric energy suitable for use by a load.

10. The fuel cell power generation device according to claim 2, further comprising:
a hydrogen-containing gas filter, connected to the first delivery pipe and configured to filter a corrosive gas in the hydrogen-containing gas;
an air filter, connected to the second delivery pipe and configured to filter a corrosive gas in the oxygen-containing gas.
